(19) United States
(12) Patent Application Publication
(10) Pub. No.: US 2026/0258748 A1
(43) Pub. Date: Sep. 3, 2026

(54) Module with Reversible Pump and Passive Check-Valves

(71) Applicant: Illinois Tool Works Inc., Glenview, IL (US)

(72) Inventors: Peter Quade, Wipperfürth (DE); Daniel Wenzel, Walsrode (DE)

(21) Appl. No.: 19/551,753

(22) Filed: Feb. 27, 2026

(30) Foreign Application Priority Data
Feb. 28, 2025 (DE) 10 2025 107 820.3
Jan. 14, 2026 (DE) 10 2026 101 533.6

(51) Int. Cl. F01P 5/10; F01P 3/20; F01P 7/14

(52) U.S. Cl. CPC F01P 5/10; F01P 3/20; F01P 7/14; F01P 2007/146

(57) ABSTRACT

A controllable pump module for a hydraulic circuit having at least a first inlet connection and at least a first outlet connection and a second outlet connection is described. The pump module comprises, among other things, a bidirectional pump for conveying a fluid between a first pump connection and a second pump connection in a first flow direction, when in a first operating state, and in a second flow direction opposite the first flow direction, when in a second operating state; a first fluid conduit with a first check valve, which is arranged between the first pump connection and the first inlet connection, and a second fluid conduit with a second check valve, which is arranged between the second pump connection and the first outlet connection, and which, with the first fluid conduit and the pump in the first operating state, causes a first fluid flow from the first inlet connection to the first outlet connection, and a third fluid conduit with a third check valve, which is arranged between the first pump connection and the second outlet connection, and a fourth fluid conduit with a fourth check valve, which is arranged between the second pump connection and the first inlet connection or a second inlet connection, and which, with the third fluid conduit and the pump in the second operating state, causes a second fluid flow from the first or second inlet connection to the second outlet connection.

### RELATED APPLICATIONS

The present application claims the benefit of German Patent Application Nos. 10 2025 107 820.3, filed Feb. 28, 2025, and 10 2026 101 533.6, filed Jan. 14, 2026, each titled “Module with Reversible Pump and Passive Check-Valves,” the contents of which are hereby incorporated by reference.

### BACKGROUND

The present disclosure relates to hydraulic circuits, and more particularly to hydraulic circuits in vehicles. More particularly, the disclosure relates primarily to thermal management systems for electric vehicles (BEV) and hybrid vehicles (PHEV, HEV). More particularly, the present disclosure relates to a pump module for controlling a hydraulic circuit.

In-vehicle thermal management is an important component for optimizing the heat or energy balance of a motor vehicle with the aim of reducing consumption and emissions, cooling or heating individual components of the drive train, as well as optimizing interior comfort.

### SUMMARY

The present disclosure relates generally to a controllable pump module, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1 illustrates a typical example of a thermal management system comprising a coolant, refrigerant and heating circuit for optimum temperature control of a battery.

FIG. 2 illustrates a flowchart of a first embodiment of the pump module of the present disclosure with a bidirectional positive displacement pump and a hydraulic circuit with an inlet and two selectively controllable outlets.

FIG. 3a illustrates a flowchart of the first embodiment of the pump module with the pump in a first operating state controlling a first outlet.

FIG. 3b illustrates a flowchart of the first embodiment of the pump module with the pump in a second operating state controlling a second outlet.

FIG. 4a illustrates a flowchart of a second, alternative, embodiment of the pump module with a controllable third outlet (outlet 1′) branching off of the first outlet (outlet 1) and a controllable second outlet (outlet 2), with the pump in a first operating state controlling the first and third branching outlet.

FIG. 4b illustrates a flowchart of a second, alternative, embodiment of the pump module with a controllable third outlet (outlet 1′) branching off of the first outlet (outlet 1) and a controllable second outlet (outlet 2), with the pump in a second operating state controlling the second outlet.

FIG. 5 illustrates a flowchart of a third, alternative, embodiment of the pump module of the present disclosure with a bidirectional positive displacement pump and a hydraulic circuit with two inlets and two controllable outlets, and

FIG. 6a illustrates a flowchart of the third embodiment of the pump module with the pump in a first operating state controlling a fluid flow from the first inlet (inlet 1) to the first outlet (outlet 1).

FIG. 6b illustrates a flowchart of the third embodiment of the pump module with the pump in a second operating state controlling a fluid flow from the second inlet (inlet 2) to the second outlet (outlet 2).

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered. It will be understood that directional references (e.g., upper, lower, upwardly, downwardly) are used for convenience with respect to the orientation shown in the figures and are not intended to limit the scope of the disclosure.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. Terms such as “can,” “may,” and “in certain embodiments” are used to reflect that variations are contemplated. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

According to a first embodiment, a controllable pump module according to the disclosure is provided for a hydraulic circuit having at least a first inlet connection and at least a first outlet connection and a second outlet connection. The pump module comprises, among other things, a bidirectional pump for conveying a fluid between a first pump connection and a second pump connection in a first flow direction, when in a first operating state, and in a second flow direction opposite the first flow direction, when in a second operating state; a first fluid conduit with a first check valve, which is arranged between the first pump connection and the first inlet connection, and a second fluid conduit with a second check valve, which is arranged between the second pump connection and the first outlet connection, and which, with the first fluid conduit and the pump in the first operating state, causes a first fluid flow from the first inlet connection to the first outlet connection; and a third fluid conduit with a third check valve, which is arranged between the first pump connection and the second outlet connection, and a fourth fluid conduit with a fourth check valve, which is arranged between the second pump connection and the first inlet connection or a second inlet connection, and which, with the third fluid conduit and the pump in the second operating state, causes a second fluid flow from the first or second inlet connection to the second outlet connection.

By means of the bidirectional positive displacement pump and the passive check valves suitably arranged in the fluid conduits, a particularly simple and robust as well as inexpensive device for controlling one or more hydraulic circuits is provided. By means of the passive check valves and fluid conduits arranged accordingly between the pump and the inlet/outlets, the various outlets can be optionally controlled only by the change in direction of the positive displacement pump. Additional pump(s) and/or switchable or controllable valves are not required.

In a preferred embodiment, the first direction of flow of the pump causes fluid flow from the first pump connection to the second pump connection and the second direction of flow of the pump causes fluid flow from the second pump connection to the first pump connection.

In a preferred embodiment, when the pump is in the first operating state, the first and second check valves are each arranged in the flow direction of the first fluid flow, and the third and fourth check valves are each arranged in the opposite direction of the first fluid flow. Thus, the fluid flow is routed through a predetermined first pumping direction and passive valve elements in the simplest manner from the first inlet connection (i.e., fluid inlet) to the first outlet connection (i.e., first fluid outlet).

In the preferred embodiment, when the pump is in the second operating state, the third and fourth check valves are each arranged in the flow direction of the second fluid flow, and the first and second check valves are each arranged in the opposite direction of the second fluid flow. Thus, the fluid flow is routed through a predetermined second, opposite, pumping direction and passive valve elements in the simplest manner from the first or second inlet connection (i.e., fluid inlet) to the second outlet connection (i.e., first fluid outlet).

Alternatively or in addition to the first embodiment, the pump module of a second embodiment comprises a fifth fluid conduit with a fifth check valve arranged between the second pump connection and a third outlet connection, and which conduit, with the first fluid conduit and the pump in the first operating state, causes a third fluid flow from the inlet connection to the third outlet connection branching off of the second fluid conduit. Thus, in a predetermined pumping direction, a fluid flow is routed from a first inlet connection simultaneously to two outlet connections. The flow rate in the individual outlets can be adjusted here, e.g., by a hydraulic adjustment, e.g., by different internal diameters of the fluid conduits.

In a preferred embodiment, the first, second, third, fourth and fifth check valves are each passive valves. This simplifies control of the pump module, thereby improving efficiency and reducing costs.

Advantageously, one or more (power) parameters of the pump are controllable and/or adjustable via a suitable interface and a corresponding control system. Preferably, the one or more parameters of the pump comprise at least one flow direction. Preferably, the one or more parameters of the pump further comprise an operating state and/or flow rate and/or flow volume and/or feed pressure. As a result, the performance parameters of the pump as well as the resulting function of the hydraulic circuit can be optimized.

In a preferred embodiment, all components of the pump module are arranged in a corresponding housing with at least a first inlet connection and at least two outlet connections in an operative and sealed manner. This allows the pump module to be simply and cost-effectively integrated into a hydraulic circuit.

The particular terms interface and controller/control unit are each to be construed as being synonymous. Furthermore, the terms “inlet/fluid inlet/inlet connection” and the terms “outlet/fluid outlet/outlet connection” are used interchangeably with one another and are interchangeable accordingly.

In principle, a check valve or one-way valve is understood by a person skilled in the art to mean a mechanical device that allows a fluid (liquid or gas) to flow in only a single direction. The valve opens automatically, e.g., by the pressure of the medium (fluid) in the forward direction and closes automatically as soon as the fluid flow stops or reverses, thereby preventing a reverse flow. The following examples describe commonly known embodiments of a check valve or one-way valve that can be passively or actively controlled.

In a ball check valve, a ball is lifted by the fluid pressure (gas or liquid) from a seal seat so that fluid may enter through the inlet. Without fluid flow, the ball is pushed into the sealing seat and the backflow is blocked.

A valve in the form of a check flap comprises a movable disc attached to a hinge, for example, moving the flap to an open position during forward flow of a fluid, and moving to a closed position during a backflow of the fluid. For example, the flap may be moved to the closed position by the dead weight or fluid pressure. Additionally, elastic elements or springs, but also levers and corresponding weights, may be employed to maintain the flap in the closed position until a predetermined fluid pressure (in the forward direction) is reached.

In a poppet check valve, a flat disc (i.e., poppet) is axially displaced by the fluid pressure. For example, the poppet may be biased towards the closed position by means of a spring. The poppet may also be replaced by a piston or the like.

An umbrella valve is an elastic valve made of rubber or silicone. The valve is configured as an umbrella that “flips over” at a particular fluid pressure so that the fluid can flow through the inlet in a forward direction. In the case of a backflow of the fluid, the umbrella is folded back to the sealing position.

In a further embodiment, the check valve is realized by a flexible membrane similar to the flapper valve. The flexible membrane is attached to the inlet opening such that the fluid pressure can push the elastic membrane open in the forward direction and push it closed against the inlet opening in the reverse direction.

In order to meet the various needs of the increasingly popular electric or hybrid vehicles, a relatively complex thermal management system is usually required. In the electric vehicles in particular, the battery must be cooled or heated according to the circumstances in order to maximize the efficiency and life of the battery. The waste heat generated in a battery cannot be removed via ambient air here and therefore must be cooled via a cooling circuit. To the same extent it is known that batteries should be kept within a predefined temperature range for optimal function/performance. For example, a cooled battery will need to be heated again upon restart. On the other hand, there is no longer any waste heat available from the internal combustion engine for the cabin, so that heat pumps must be used for example.

In order to be able to provide the required temperatures (i.e., heat or cooling), the appropriate hydraulic circuits of the thermal management system must interact together optimally. Pumps and suitable valves are typically arranged to control the circuits in such a way that a desired switching state can be realized. In the relatively complex thermal management systems of the electric or hybrid vehicles, multiple (different) pumps and a plurality of actively controllable switching valves are often required, which not only takes up a lot of space, but is also very cost-intensive and is also very inefficient due to the increased energy consumption (e.g., due to pumping). For example, the many more complex components require more intensive maintenance and also cause higher costs when repair or replacement is required.

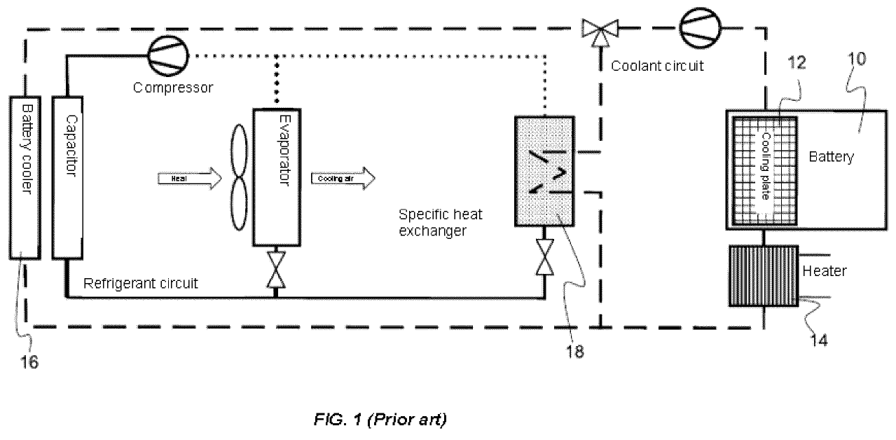

FIG. 1 shows a typical application example for temperature management in an electric vehicle, where batteries having a larger capacity are used and proper temperature control plays a central role, with the example being applicable to hybrid vehicles having smaller batteries as well. As already mentioned, at low temperatures in particular, additional heating of the battery is necessary in order to bring it into the ideal temperature range. In the illustrated example, the battery 10 may be incorporated into a secondary circuit. This circuit ensures that the ideal operating temperature can be maintained permanently.

In the battery block 10, coolant, composed of water and glycol for example, then flows through a built-in cooling plate 12 (dashed line). At low temperatures, the coolant may then be rapidly heated via a heater 14 to reach the ideal temperature. If a temperature increases in the battery 10 occurs during use of the hybrid functions, the heater 14 is switched off. The coolant may then be cooled down through the battery cooler 16 or the low-temperature radiator located in the front of the vehicle by means of wind speed.

If cooling by the battery cooler 16 is not sufficient at high outside temperatures, the coolant will pass through a specific heat exchanger 18. In this heat exchanger, the refrigerant of the vehicle air conditioner is evaporated. In addition, heat may be transferred from the secondary circuit to the evaporating refrigerant very compactly and at a high-power density. The coolant is additionally recooled. By using the specific heat exchanger 18, the battery 10 can be operated within the optimal temperature range for maximum efficiency.

Consequently, the object of the present disclosure is to at least partially address the disadvantages described above. In particular, the object of the present disclosure is to improve thermal management systems with hydraulic circuits in a cost-effective and simple manner. It is a further object of the present disclosure to provide a pump module, via which one or more hydraulic circuits of a thermal management system, but also a drive train or oil supply system, can be controlled and/or regulated in the simplest way.

The exemplary application described herein relates to thermal management systems configured for use in battery electric vehicles (BEVs) or hybrid vehicles that dynamically, selectively and independently regulate the drive and battery system components (e.g., heat or cool them). The system described in the example utilizes a positive displacement pump, such as a screw pump, with passive check valves (i.e., one-way valves), simplifying the architecture and improving efficiency. More particularly, the present disclosure relates to a pump module for controlling hydraulic circuits in electric or hybrid vehicles to optimize heating and cooling, and thus battery temperature control. The architecture utilizes the bidirectional capability of the positive displacement pump, e.g., a screw pump in the areas of flow reversal, along with inexpensive passive check valves. This configuration eliminates or reduces the number of electronically actuated switching valves, simplifies control mechanisms, and increases the overall efficiency and reliability of the temperature control system. Alternatively, a second water pump may also be omitted if the circuits would each be operated with their own pumps instead of the use of the reversible positive displacement pump.

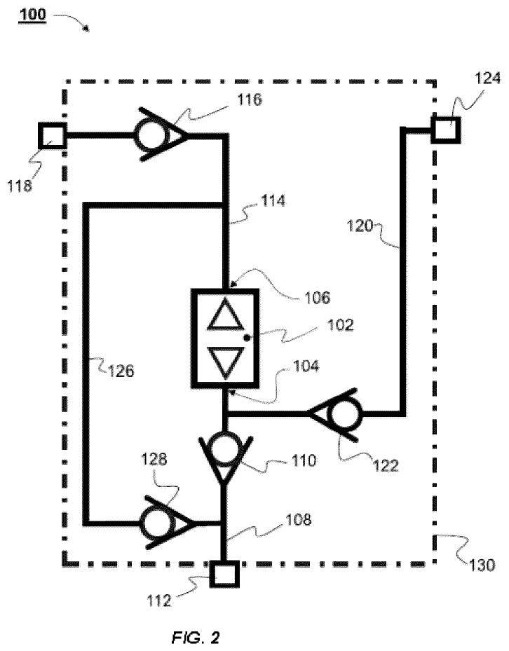

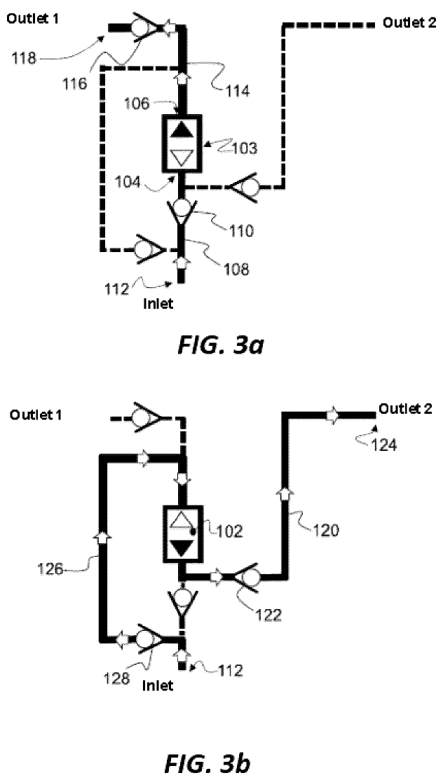

Referring to FIGS. 2, 3a, 3b, 4a, and 4b, the pump module 100 according to the present disclosure is described based on a schematic flow chart of the hydraulic circuits. As shown in FIG. 2, the pump module 100 comprises a bidirectional positive displacement pump 102, e.g., a screw pump, with a first pump connection 104 and a second pump connection 106, each acting as an inlet (suction) and outlet (exhaust) in a first operating state (first direction) of the pump 102, and as an outlet (exhaust) and inlet (suction) in a second operating state (second direction) of the pump 102. In the example described herein, the fluid flows from the first pump connection 104 to the second pump connection 106 when the pump 102 is in the first operating state and from the second pump connection 106 to the first pump connection 104 when the pump 102 is in the second operating state (see FIGS. 3a and 3b).

A first fluid conduit 108 with a passive first check valve 110 that is open to the first pump connection 104 connects a first inlet connection 112 of the module 100 to the first pump connection 104. A second fluid conduit 114 with a passive second check valve 116 that is closed to the second pump connection 106 connects a first outlet connection 118 of the module 100 to the second pump connection 106. A third fluid conduit 120 with a passive third check valve 122 that is closed to the first pump connection 104 connects the second outlet connection 124 of the module 100 to the first pump connection 104. A fourth fluid conduit 126 with a passive fourth check valve 128 that is open to the second pump connection 106 connects the first inlet connection 112 of the module 100 to the second pump connection 106.

The check valves 110, 116, 122, 128, also referred to as one-way valves, embody a mechanical device that allows the fluid to flow in only one direction. That is, the check valves 110, 116, 122, 128 are designed to prevent backflow into the respective fluid conduits 108, 114, 120, 126, thereby achieving fluid flow from the first inlet connection 112 to a desired outlet connection 118, 124, as a function of the operating state of the pump 102. The passive check valves 110, 116, 122, 128 are automatically triggered by the fluid pressure acting in the open direction, unlike controllable control valves, and thus need no control or manual actuation. As a result, the pump module 100 is particularly robustly and efficiently configured, wherein the desired outlet 118, 124 can be controlled in the simplest manner only via the pump direction.

FIGS. 3a and 3b illustrate the various flow states, with a fluid flow in the first operating state of the pump 102 from the first inlet connection 112 to the first outlet connection 118, since only the first check valve 110 and the second check valve 116 are in the open direction to the fluid flow (generated by the pump 102). In the second operating state of the pump 102, a fluid flow opposite that of the first operating state is effected from the first inlet connection 112 to the second outlet connection 124 because only the fourth check valve 128 and the third check valve 122 are in the open direction to the fluid flow.

In a preferred embodiment, the pump module 100, 100′, 100′′ comprises a housing 130 that encloses the positive displacement pump 102, the fluid conduits 108, 114, 120, 126, and the check valves 110, 116, 122, 128, such that only the first inlet connection 112 (and as described later also the second inlet connection 138), the respective outlet connections 118, 124 (and as described later also the third outlet connection 134), and an interface/controller controlling the pump 102 (interface with a control unit, can also be wirelessly controllable) are operable by the user. The pump module 100, 100′, 100′′ can thus be immediately operably integrated as an independent (freestanding) module in various hydraulic circuits. The pump module 100, 100′, 100′′ of the present disclosure is primarily intended for thermal management in electric or hybrid vehicles, but may also be used in powertrain and oil supply circuits alike.

The interface/controller (not shown) controlling the pump 102 may accordingly be configured to be manually actuatable by the user. Alternatively (and preferably) the control unit (controller) may also be activated and/or controlled via a correspondingly configured interface with an electrical (e.g., wired) or wireless connection. The control unit (i.e., the controller) of the pump 102 may be configured to control various performance parameters of the pump 102, such as pump direction, flow rate, or fluid flow volume. Moreover, the control unit (controller) may also be configured to measure the power consumption of the pump, for example. The control unit may also comprise various sensors arranged on the pump 102 and/or in the housing and/or on the check valves, which are suitable for measuring temperature, fluid flow, or pressure, for example, wherein the measured data may then be retrieved by the user or another control system as needed. The control unit may also be configured to actuate a switching valve to selectively connect the second inlet connection 138 (described later) to the fourth fluid conduit 126.

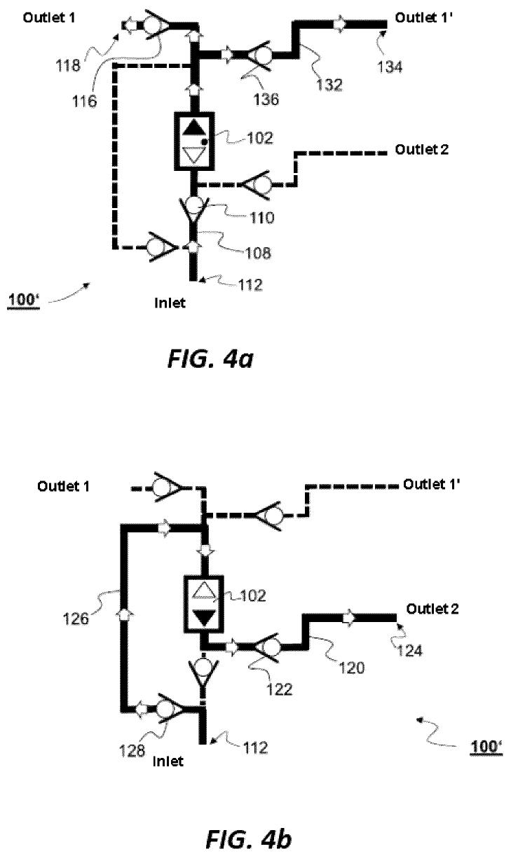

FIGS. 4a and 4b illustrate the various flow states of a first alternative embodiment of the pump module 100′, which, in its construction and basic function, is substantially identical to the preferred embodiment described in FIGS. 3a and 3b, wherein, via an additional fifth fluid conduit 132 branching off of the second fluid conduit 114, a third outlet connection 134 is provided with a passive fifth check valve 136 that is open to the third outlet connection 134. Thus, in the first operating state of the pump 102, a fluid flow from the first inlet connection 112 is now effected not only to the first outlet connection 118 but also to the branched third outlet connection 134 as only the first check valve 110, the second check valve 116, and the fifth check valve 136 are in the open direction to the fluid flow (generated by the pump 102). In the first operating state, hydraulic adjustment between the first and third outlet connections 118, 134 may be required, for example, which may be controlled via the volume flow generated by the pump.

In the second operating state of the pump 102, as already shown in the first embodiment (see FIGS. 3a and 3b), a fluid flow opposite to that of the first operating state is effected from the first inlet connection 112 to the second outlet connection 124 because only the fourth check valve 128 and the third check valve 122 are in the open direction to the fluid flow.

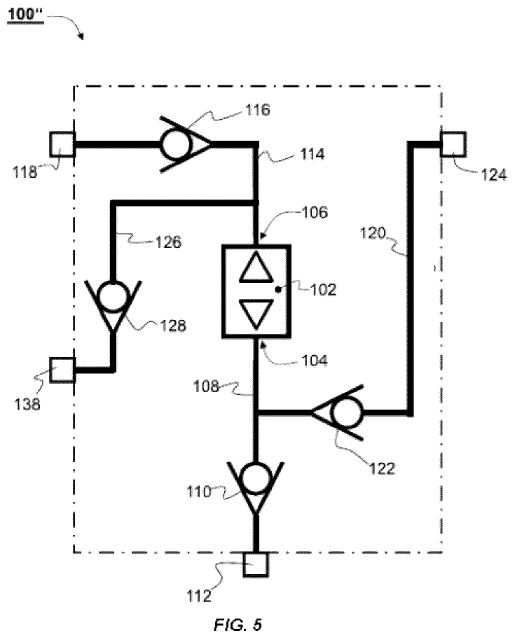

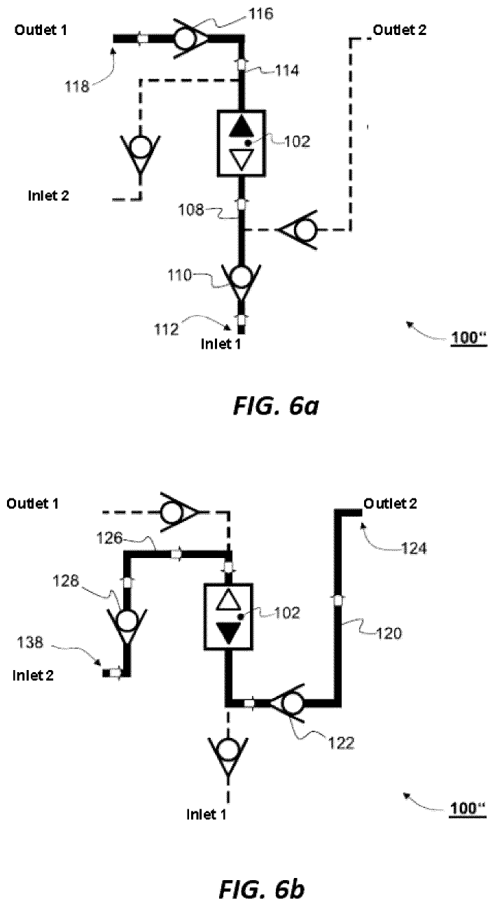

FIG. 5 illustrates a second alternative embodiment of the pump module 100″ of the present disclosure, and FIGS. 6a and 6b show the possible flow conditions through the bidirectional positive displacement pump 102. The second alternative embodiment of the pump module 100″, in its construction and basic function, substantially corresponds to the embodiment described in FIG. 2, wherein the fourth fluid conduit 126 leads to a second inlet connection 138 instead of leading to the first inlet connection via the fourth check valve 128. Thus, the second alternative embodiment of the pump module 100″ has first and second inlet connections 112, 138 and first and second outlet connections 118, 124, which may each be controlled via the direction of the bidirectional positive displacement pump 102. The second inlet connection 138 may be formed in a separate embodiment of the pump module 100″, or may simply be added subsequently as a selectively controllable second inlet connection 138 in the embodiment of the pump module 100 (see FIG. 2). That is, the second inlet connection 138 may be optionally added via, for example, a switching valve (not shown) operably integrated into the fourth fluid conduit 128 between the fourth check valve 128 and the first inlet connection 112.

FIGS. 6a and 6b illustrate the two different flow states, with a fluid flow in the first operating state of the pump 102 from the first inlet connection 112 to the first outlet connection 118, since only the first check valve 110 and the second check valve 116 are in the open direction to the fluid flow (generated by the pump 102). In the second operating state of the pump 102, a fluid flow opposite to that of the first operating state is effected from the second inlet connection 138 to the second outlet connection 124 because only the fourth check valve 128 and the third check valve 122 are in the open direction to the fluid flow.

While the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

### LIST OF REFERENCE NUMERALS

10 Battery block
12 Cooling plate
14 Heater
16 Battery cooler
18 Heat exchanger
100 Pump module
102 Positive displacement pump
104 First pump connection
106 Second pump connection
108 First fluid conduit
110 First check valve
112 First inlet connection
114 Second fluid conduit
116 Second check valve
118 First outlet connection
120 Third fluid conduit
122 Third check valve
124 Second outlet connection
126 Fourth fluid conduit
128 Fourth check valve
130 Housing
132 Fifth fluid conduit
134 Third outlet connection
136 Fifth check valve
138 Second inlet connection

What is claimed is:

1. A controllable pump module for a hydraulic circuit having at least a first inlet connection and at least a first outlet connection and a second outlet connection comprising:
a bidirectional pump for conveying a fluid between a first pump connection and a second pump connection in a first flow direction when in a first operating state, and in a second flow direction opposite to the first flow direction when in a second operating state;
a first fluid conduit with a first check valve, which is arranged between the first pump connection and the first inlet connection, and a second fluid conduit with a second check valve, which is arranged between the second pump connection and the first outlet connection, and which, with the first fluid conduit and the pump in the first operating state, causes a first fluid flow from the first inlet connection to the first outlet connection;
a third fluid conduit with a third check valve, which is arranged between the first pump connection and the second outlet connection, and a fourth fluid conduit with a fourth check valve, which is arranged between the second pump connection and the first inlet connection or a second inlet connection, and with the third fluid conduit and the pump in the second operating state, causes a second fluid flow from the first or second inlet connection to the second outlet connection.

2. A controllable pump module according to claim 1, wherein the first flow direction of the pump causes a fluid flow from the first pump connection to the second pump connection, and that the second direction of flow of the pump causes a fluid flow from the second pump connection to the first pump connection.

3. A controllable pump module according to claim 1, wherein when the pump is in the first operating state, the first and second check valves are each arranged in the flow direction of the first fluid flow, and the third and fourth check valves are each arranged in the opposite direction of the first fluid flow.

4. A controllable pump module according to claim 1, wherein when the pump is in the second operating state, the third and fourth check valves are each arranged in the flow direction of the second fluid flow, and the first and second check valves are each arranged in the opposite direction of the second fluid flow.

5. A controllable pump module according to claim 1, wherein the pump module comprises a fifth fluid conduit with a fifth check valve arranged between the second pump connection and a third outlet connection, and which conduit, with the first fluid conduit and the pump in the first operating state, causes a third fluid flow from the first inlet connection to the third outlet connection branching off of the second fluid conduit.

6. A controllable pump module according to claim 1, wherein the first, second, third, fourth, and fifth check valves are each passive valves.

7. A controllable pump module according to claim 1, wherein one or more (power) parameters of the pump are controllable and/or adjustable and/or monitorable via a suitable interface and a corresponding control system.

8. A controllable pump module according to claim 7, wherein the one or more parameters of the pump comprise at least one flow direction.

9. A controllable pump module according to claim 8, wherein the one or more parameters of the pump further comprise an operating state and/or flow rate and/or flow volume and/or feed pressure.

10. A controllable pump module according to claim 1, wherein all components of the pump module are arranged in a corresponding housing with at least a first inlet connection and at least two outlet connections in an operative and sealed manner.
